(19) United States
(12) Patent Application Publication
(10) Pub. No.: US 2023/0111004 A1
(43) Pub. Date: Apr. 13, 2023

(54) INSTANT WIN MULTIPLE PATH SYMBOL MATCHING

(71) Applicant: IGT, Las Vegas, NV (US)

(72) Inventors: David TWOMEY, Berkhamsted (GB); Kevin FROSTICK, Hemel Hempstead (GB); Ray LATHAM, Farnworth (GB); Chris COSTELLO, Romiley (GB)

(73) Assignee: IGT, Las Vegas, NV (US)

(21) Appl. No.: 17/485,716

(22) Filed: Sep. 27, 2021

(51) Int. Cl. G07F 17/32; G07F 17/34

(52) U.S. Cl. CPC G07F 17/3262; G07F 17/34; G07F 17/3213; G07F 17/3258

(57) ABSTRACT

Provided are methods that include operations of displaying, using a display device, a grid including multiple cells and displaying, using the display device, a selection graphic that includes multiple mystery elements that each correspond to a different one of multiple symbol types that are configured to be displayed on the plurality of cells, displaying, using the display device, a vertical connector that is arranged between two adjacent ones of the rows of cells and receiving, at the selection graphic, an input that selects a portion of the symbol types, highlighting a portion of the cells that include the portion of the symbol type and determining an award that is identified based on which symbols are on the plurality of cells that are in the award path.

### BACKGROUND

Electronic instant win gaming machines may provide players awards for matching one or more symbols. A player may select cells to be revealed and the player may be provided an award based on which symbols get revealed.

### BRIEF SUMMARY

In some embodiments, the present disclosure is related to an electronic gaming machine (EGM) that includes a processor circuit and a memory device which stores a plurality of instructions, which when executed by the processor circuit, cause the processor circuit to perform operations including causing a display device to display a grid including multiple cells that are arranged as rows of cells that each define a corresponding path between a first row identifier that corresponds to a beginning of the row and a second row identifier that corresponds to an end of the rows. Operations include causing the display device to display a selection graphic that includes multiple mystery elements that each correspond to a different one of a plurality of symbol types that are configured to be displayed on the plurality of cells. The mystery cells may be removed to reveal the symbol types of the cells.

Operations include causing the display device to display multiple vertical connectors that are arranged between adjacent ones of the rows of cells and may each be arranged between two adjacent ones of the rows. Operations include receiving (block 708) an input at the selection graphic. The input may select a portion of the symbol types.

Operations include causing the display to highlight a portion of the cells that include the portion of the symbol types. In response to determining that the portion of the cells that are highlighted include all of the cells in one of the rows, operations include determining a first award that is identified based on the second row identifier of the corresponding row. In response to determining that the portion of the cells that are highlighted include highlighted ones of the cells that define a path that includes adjacent ones of a first portion of the cells on a first one of the rows, adjacent ones of a second portion of the cells one a second one of the rows, and one of the vertical connectors, operations include determining a second award that is identified based on the second row identifier of the second one of the rows.

Methods are provided that include operations for operating a game providing instant win multiple path symbol matching according to some embodiments. Operations include displaying, by a display device, a grid including multiple cells that are arranged as multiple rows of cells that correspond to paths between multiple beginning row identifiers and multiple ending row identifiers. Operations further include displaying, by the display device, multiple symbols on the cells. In some embodiments, the symbols include multiple symbol types that each include a portion of the symbols. Operations include displaying, by the display device, a selection graphic that includes a first spinner that is used to select one of the beginning row identifiers and a second spinner that is used to select one of the ending row identifiers.

Operations further include displaying, by the display device, multiple horizontal connectors that are arranged between adjacent ones of the cells in each of the rows of cells and multiple vertical connectors that are arranged between adjacent ones of the rows of cells. Operations include receiving, by the processor circuit and via the selection graphic, an input that selects one of the beginning row identifiers and one of the ending row identifiers.

Operations include generating an award path between a selected one of the beginning row identifiers and a selected one of the ending row identifiers and that includes a first horizontal connector on a first row corresponding to the selected one of the beginning row identifiers, a second horizontal connector on a second row corresponding to the selected one of the ending row identifiers, and one of the vertical connectors.

Operations include highlighting ones of the cells that are in the award path and determining that the cells that are highlighted include all of the cells in the award path. Operations include, responsive to determining the cells that are highlighted comprise all of the cells in the award path, determining an award.

Embodiments herein include methods including operations of displaying, using a display device, a grid including multiple cells and displaying, using the display device, a selection graphic that includes multiple mystery elements that each correspond to a different one of multiple symbol types that are configured to be displayed on the plurality of cells. Operations include displaying, using the display device, a vertical connector that is arranged between two adjacent ones of the rows of cells and receiving, at the selection graphic, an input that selects a portion of the symbol types.

Operations include highlighting a portion of the cells that include the portion of the symbol type and determining that the portion of the cells that are highlighted generate a path from a first end of one of the adjacent rows of cells to a second end of another one of the adjacent one of rows of cells and that includes the vertical connector. Operations include determining an award that is identified based on which symbols are on the plurality of cells that are in the award path.

Additional features are described herein and will be apparent from the following Detailed Description and the figures.

### BRIEF DESCRIPTION OF THE DRAWINGS

FIGS. 1A-1C are a schematic screenshots of multiple play grids in a standard main game according to some embodiments.

FIGS. 2A-2E are schematic screenshot of a play grid in a connect and collect game according to some embodiments.

FIGS. 3A-3E are schematic screen shots of a symbol game according to some embodiments herein.

FIGS. 4A-4C are schematic screen shots of a symbol game according to some embodiments herein.

FIGS. 5A and 5B are perspective views of some embodiments of the gaming system disclosed herein.

FIG. 5C is a front view of some embodiments of a personal gaming device of the gaming system disclosed herein.

FIG. 6 is a schematic block diagram some embodiments of an electronic configuration of an example gaming system disclosed herein.

FIG. 7 is a flow chart of some embodiments of processes for operating a game providing instant win multiple path symbol matching according to some embodiments.

FIG. 8 is a flow chart of some embodiments of processes for operating a game providing instant win multiple path symbol matching according to some embodiments.

FIG. 9 is a flow chart of some embodiments of processes for operating a game providing instant win multiple path symbol matching according to some embodiments.

### DETAILED DESCRIPTION

In various embodiments, the present disclosure relates generally to systems and methods that provide a player zero, one or more awards based locations and/or quantities of symbols in a play grid of symbols. For example, the player may reveal a number of play symbols that are highlighted in the play grid of symbols. bonus symbols for two bonus games may also be revealed. If the player reveals enough of a bonus symbol, access to a relevant bonus game may be triggered. In some embodiments, the play grid of symbols contains multiple paths to multiple prizes. If the player marks off all the symbols on any of the paths to the multiple prizes, the player may win the prize associated with that path. Some embodiments provide that if the player reveals a bonus game symbol, that player may get to play an additional bonus game with a guaranteed prize win. In some embodiments, if the player reveals a given quantity of multiplier bonus game symbols, they get to play an additional multiplier bonus game that multiplies all existing wins by the revealed Multiplier factor.

Some embodiments provide that the game may include several possible game parts. For example, the game may include a standard main game, an optional bonus game and an optional multiplier bonus game.

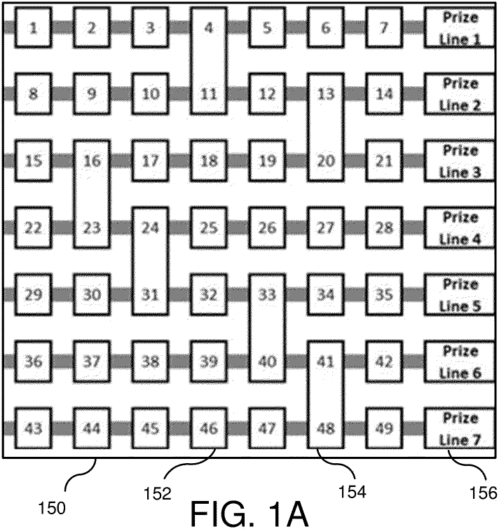

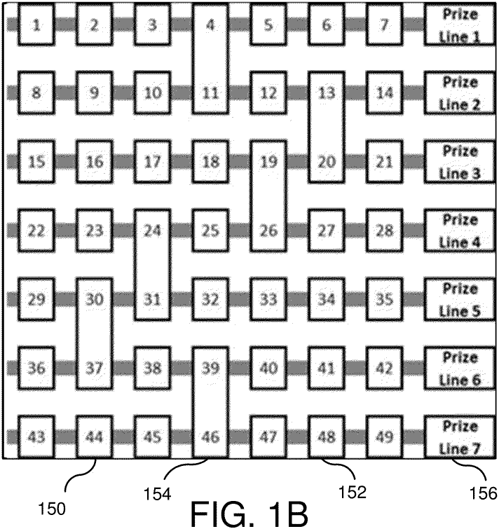

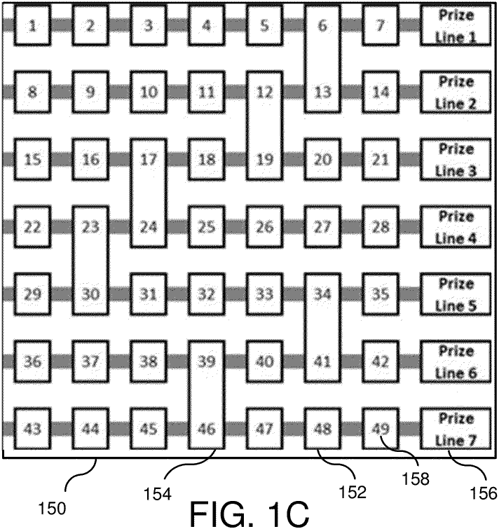

Reference is now made to FIGS. 1A-1C, which are a schematic screenshots of multiple play grids in a standard main game according to some embodiments. As illustrated, some embodiments provide that in the main game, the player may be presented with a play grid of symbols. In some embodiments, the play grid area 150 includes seven rows and seven columns of symbol cells 152, 154. However, such dimensions are non-limiting as the play grid area 150 may include more or less than seven rows and/or columns. The play grid area 150 may include a column of prize lines 156 that identify a prize if a chain of connected symbols reaches a corresponding prize line 156. The play grid area 150 may contain symbol cells 152, 154 that may include two types of symbols. For example, one type of symbol cell may include single square cells 152 and twin cells 154 that may connect cell positions in adjacent rows of the same grid column. For example, the play grid area 150 may include 37 single square cells 152 and 6 twin cells 154. In some embodiments, the twin cells 156 may be displayed as individual cells that include the same mystery element and/or may be connected by a vertical element to identify an alternate path relative to the strictly horizontal path between adjacent cells in a given row.

In some embodiments, there may be only a single vertical connection between each pair of rows, which may ensure that there is a unique path between each start point and each end point. In this regard, a game with 7 rows of cells may have either 6 vertical connections or 6 over-sized cells, which would mean 49-6-43 regular-sized cells in a game with a 7x7 grid. Some embodiments provide that a game with “R” rows will have either (R-1) vertical connections or (R-1) over-sized cells.

As illustrated, the play grid area 150 in FIG. 1A provides that 7 cells in each row are horizontally connected. As illustrated, some embodiments provide that three play grid areas 150 may be used in a single game. However, such quantity of play grid areas 150 is non-limiting as a game according to some embodiments may include more or less than three play grid areas 150.

In some embodiments, each of the cells 152, 154 may include one of multiple symbols that are available. In some embodiments, mystery elements 158 may be displayed in each cell 152, 154 and may conceal which of the symbols are in each of the cells 152, 154. Some example embodiments provide that there are a total quantity of available symbols and that the player may select a portion of the available symbols to reveal. Some examples provide that the total quantity of available symbols is nine symbols and that the player selects six of the nine symbols to play. Each occurrence of the selected symbols in the play grid area 150 is uncovered. In some embodiments, the twin cells 154 act as junctions creating paths that involve more than one row.

Some embodiments provide that each grid may contain 7 symbols that each appear 5 times and 2 symbols that each appear 4 times. In some embodiments, the 2 symbols that appear 4 times may have a distribution such as: 15 times per 36 plays in which both symbols appear as play symbols; 18 times per 36 plays in which one symbol appears as a play symbol and one symbol appears as a non-play symbol; and 3 times per 36 plays in which both symbols may appear as non-play symbols.

Each of the 3 usable layouts of the example illustrated in FIGS. 1A-1C may include 27 different paths to the prize column. In the current example, each of the 27 different paths may contain no more than 6 different symbols. If the player uncovers all the symbols on any of the paths to one of the prize lines 156, they win the prize associated with that prize line 156.

In some embodiments, the player may win up to 2 prizes in a main game. Some embodiments provide that it is possible to win any 2 prize lines 156 in the same game, although not all paths to each prize line 156 can be used in combination. For example, using the play grid area of FIG. 1A, if cells 1-14 contained matched symbols, the path using cells 1-7 may cause a prize line 1 win and the path using cells 8-14 may cause a prize line 2 win. However, the path using cells 1-4 with 11-14 may cause a second win of prize line 2 and the path using cells 8-11 with 4-7 may cause a second win of prize line 1.

Some embodiments provide that all valid winning paths may move strictly from left to right. In some embodiments, valid winning paths may pass up and down through a junction, however, a double-back path that involves one that involves any movement from right to left) may not be valid. In the illustrated embodiments, each of the play grid areas 150 of FIGS. 1A-1C may have multiple double-back paths that may be prevented from consisting of matched symbols.

Some embodiments may not allow any winning paths that included any double-backs and thus only the paths that didn’t include double-backs may be used therein. In this manner, an increased variety was provided in the ways that players could win more than one prize. In some embodiments, a game may include winning paths with double-backs. In some non-limiting embodiments, 7x7 grid layouts with 27 possible non-double-back paths were used. The other 22 paths involved double-backs. In some embodiments, 7x7 grid layouts in which all 49 possible paths (e.g., double-back and non-double-back) may be provided.

According to some embodiments, multiple main game prizes may be available to win. After the player selects a portion of the symbols as their play symbols, a fixed portion of the prizes may appear in every play while a portion of the prizes may appear alternatively with other ones of the prizes. For example, 9 different prizes (A-I) are available in a main game. The player may reveal 6 of the 9 different symbols as their play symbols. Prizes A & B, and G, H and I may appear in every play. Each play may feature either prize C or D (but not both) and may feature either prize E or F (but not both).

Some embodiments provide that each time the player reveals a play symbol they may also reveal one of two types of bonus symbols. The bonus symbol types may include a bonus game symbol and a multiplier bonus game symbol. Some embodiments provide that a maximum of one bonus symbol will be revealed on any turn. If the player reveals one bonus game symbol a guaranteed win bonus game that will be played once the main game has finished may be triggered. Some embodiments provide that a player may not reveal more than one bonus game symbol in total.

Some embodiments provide that if the player reveals 3 multiplier bonus game symbols, they may trigger the multiplier bonus game that may be played once the main game has finished. In some embodiments, no player may reveal more than 3 multiplier bonus game symbols in total. If both the bonus game and the multiplier bonus game are triggered, the bonus game may be played first. In some embodiments, players may only collect a 3^{rd} multiplier bonus game symbol after one of: a prize has been awarded in the Main game; and a bonus game symbol has been collected in the main game.

In some embodiments, the bonus game may include a number of cells. Each cell may contain either a prize amount (B1-B11) or a bonus over symbol (X). The player may choose a cell to reveal its contents. If the cell contains a prize (B1-B11), the player collects that prize and makes another cell choice. If the cell contains a bonus over symbol (X), the Bonus Game finishes. Some embodiments provide that a player will always win at least one prize in the bonus game. In some embodiments, a maximum number of prizes that may be won in the bonus game may be a fixed number.

Some embodiments provide that a multiplier game may be provided. In some embodiments, a player may play the multiplier game if they have already won a cash prize. This can either be by completing one or more paths in the main game, or by collecting one or more prizes in the bonus game. In some embodiments, the player reveals a multiplier value in the multiplier game. The player’s total winnings may be multiplied by the multiplier value. non-limiting examples of available multipliers include: x2 (M2); x3 (M3); x4 (M4); and/or x5 (M5), among others.

In winning games, players may win up to 2 times in the main game. A player who plays the bonus game may always win at least one prize during the course of the bonus game. In some embodiments, players may win up to 6 times in the bonus game. It may be possible to win in the main game, the bonus game and the multiplier game in the same play. Some embodiments provide that no main play winner may complete more than one path to the same prize amount.

In non-winning games, plays may always have a near win in the main game. In some embodiments, a near win may be defined as a play where, after 5 play symbols have been revealed in the main game, the player has one or more paths that would be completed if one of the remaining symbols was revealed. Some embodiments provide that multiple variations of winning and non-winning scenarios may be possible.

Available data includes main game data, bonus game data and multiplier game data that may be separated by a designated character. The main game data may include comma-separated strings including: prizes (A-I) associated with each prize line from prize line 1 to prize line 7; the ordering of the 9 play symbols (R-Z) including that the first 6 letters are the play symbols in play order and the 7^{th}-9^{th} symbols are the unmatched symbols; the bonus data to reveal on each of the 6 turns in turn order and that outcomes may include a character indicating that there is no bonus symbol; a character indicating that a bonus game symbol is collected and a character indicating that a multiplier bonus game symbol is collected.

In some embodiments, main game data may include identification regarding which grid layout reference to use including which symbol to place in each of the grid cell positions.

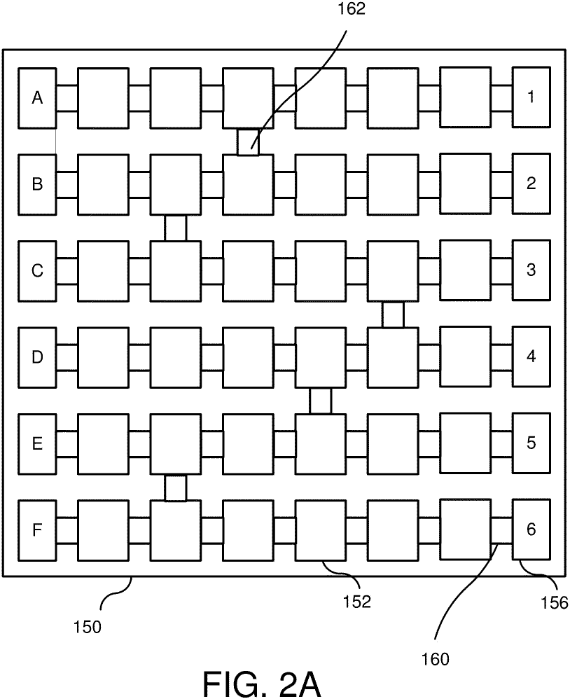

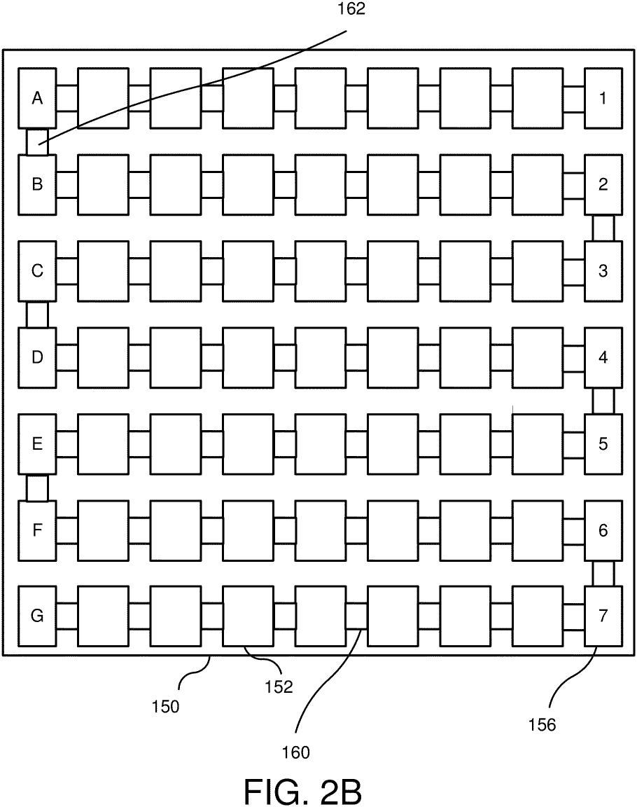

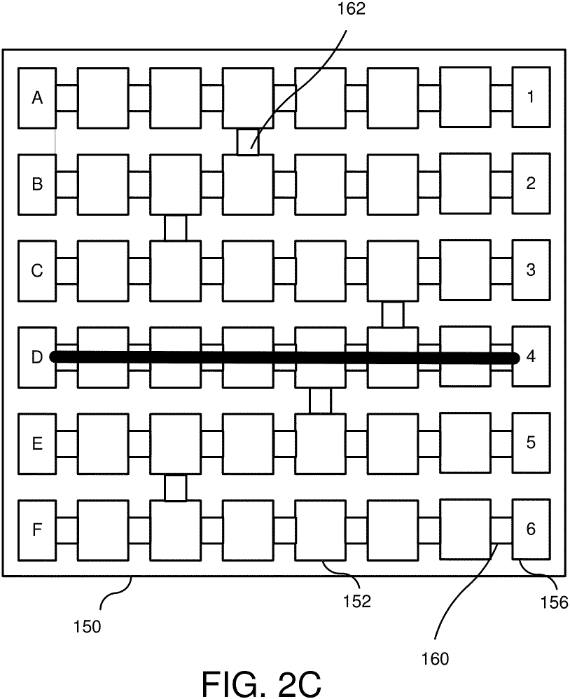

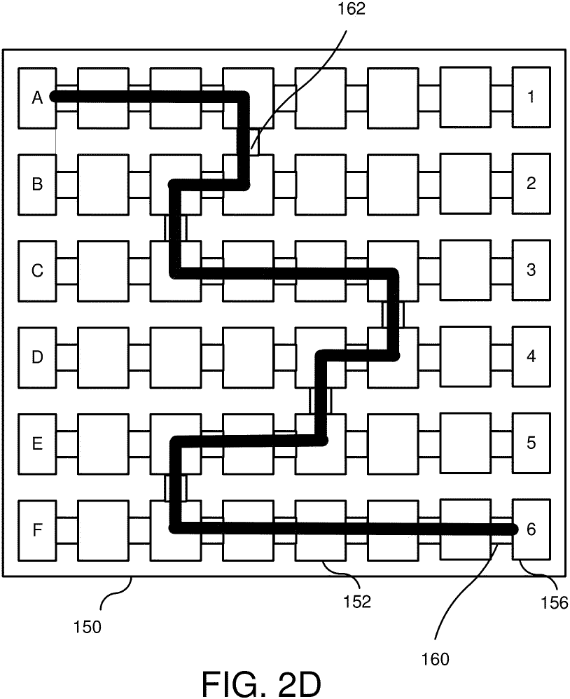

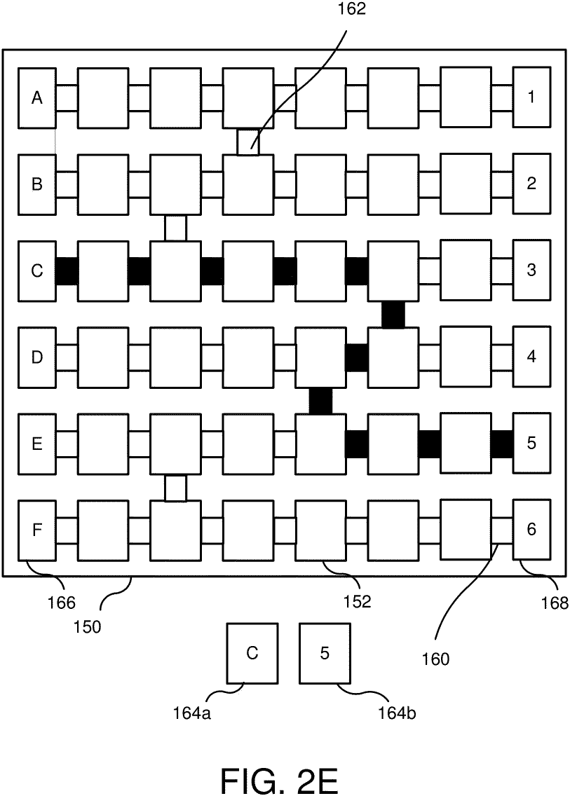

Reference is now made to FIGS. 2A-E, which are schematic screenshot of a play grid in a connect and collect game according to some embodiments. Referring to FIG. 2A, a play grid area 150 may include a rectangular grid of cells 152. Although illustrated as a six-by-six grid, embodiments herein are not so limited as the grid can include rows and/or columns having more or less the six cells 152. Cells 152 that are within each row are interconnected using horizontal connectors 160. In some embodiments, each row may start and end with a row reference. As a non-limiting example, the rows may begin with alphabet letters and may end with numerals, however, any other suitable reference schemes are within the scope and spirit herein. For example, rows may start with letters A-F and end with numerals 1-6.

Although grids described herein are generally presented as grids of horizontally connected cells with a small number of vertical connections, such embodiments are non-limiting. For example, embodiments herein may include grids of vertically connected cells with a small number of horizontal connections

Some embodiments provide that there may be a single vertical connection 162 between corresponding elements of adjacent rows. Some embodiments provide that the vertical connections 162 may stay in the same position during a game while other embodiments provide that the vertical connectors 162 may move between turns. In some embodiments, the vertical connectors 162 may be randomly positioned.

Briefly referring to FIG. 2B, a starting point in an animation of the vertical connectors 162 may begin at the identified locations. The animation may cause the vertical connectors 162 to attract attention and then result in the vertical connectors 162 stopping at different positions. In some embodiments, the vertical connectors 162 may appear at predesignated positions. Some embodiments provide that the vertical connections 162 are configured such that there is a unique path from each letter to each number.

Brief reference is now made to FIG. 2C, which illustrates that some paths to a prize line 156 may be direct. For example, as illustrate by the path line, the path may be from the “D” reference straight to the “4” reference without accessing any of the vertical connections 162. Briefly referring to FIG. 2D, in some embodiments, the path to a prize line 156 may include one or more different vertical connections 162.

Briefly referring to FIG. 2E, each of the cells 152 may correspond to a symbol and/or a prize amount. In some embodiments, a starting point 166 for the path may be determined by which of the starting point values is selected in a starting point value selector 164a. Similarly, an ending point 168 of the path may be determined by which of the ending point values is selected in an ending point value selector 164b. The example is illustrated to provide that “C” is the starting point 166 for the path and “5” is the ending point 168.

In some embodiments, the starting and ending point selectors 164a, b may be automatically generated responsive to receiving an input from a player. For example, graphically generated and/or physical spinners may be used as the starting and ending point selectors 164a, b. The grid cells 152 are along the path that is defined by the starting and ending points of the path. In some embodiments, the contents of the grid cells 152 identify and/or determine what symbols are revealed and/or which prize amounts or other awards are collected. For example, in the case of a symbol-based game, all of the symbols in cells 152 that are on the path may be collected.

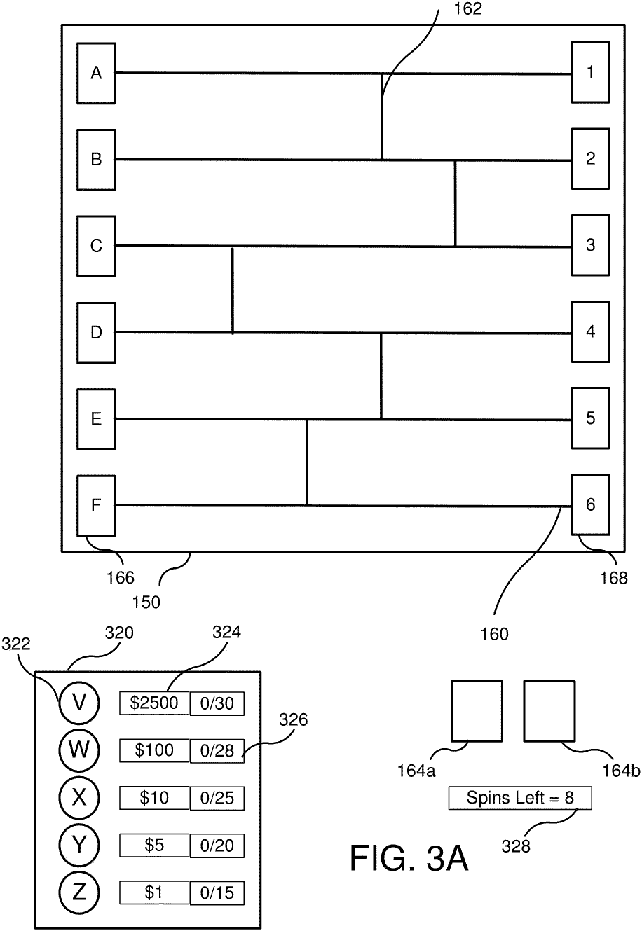

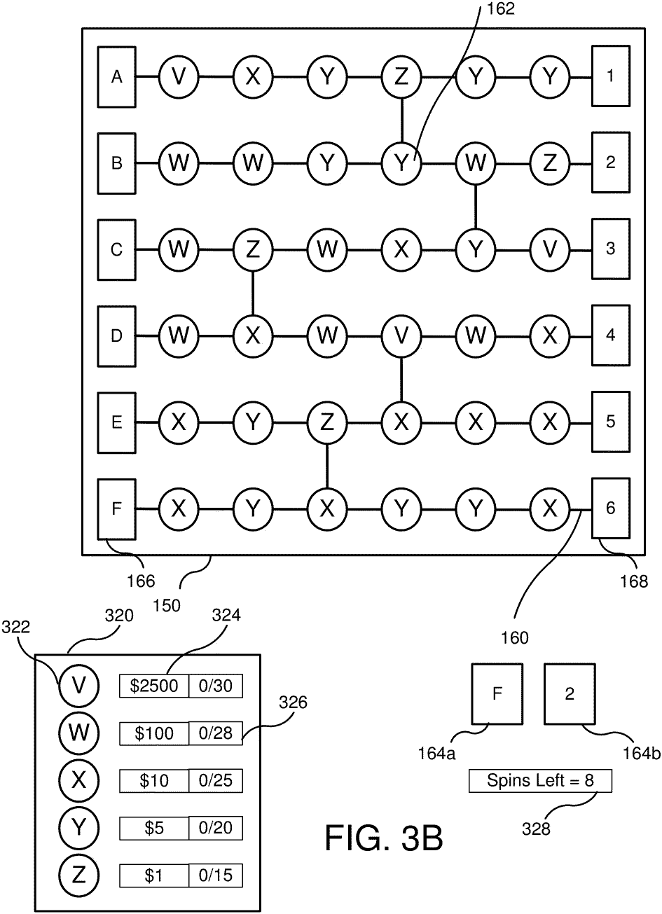

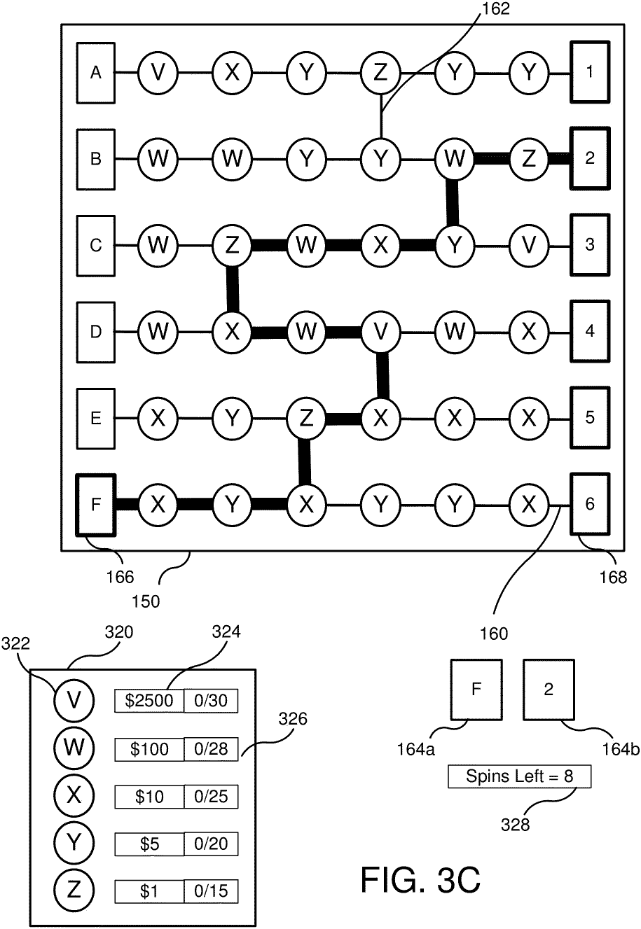

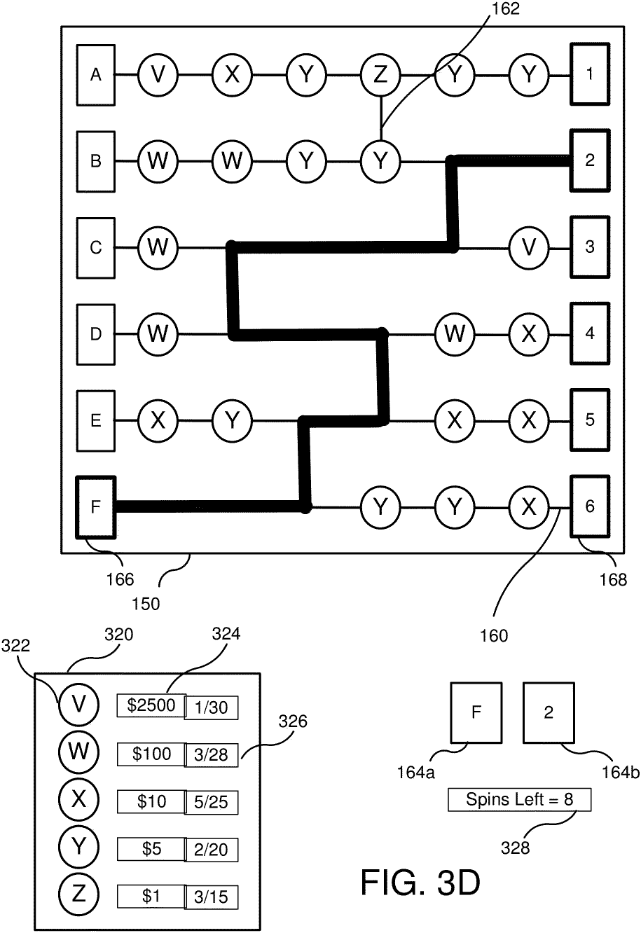

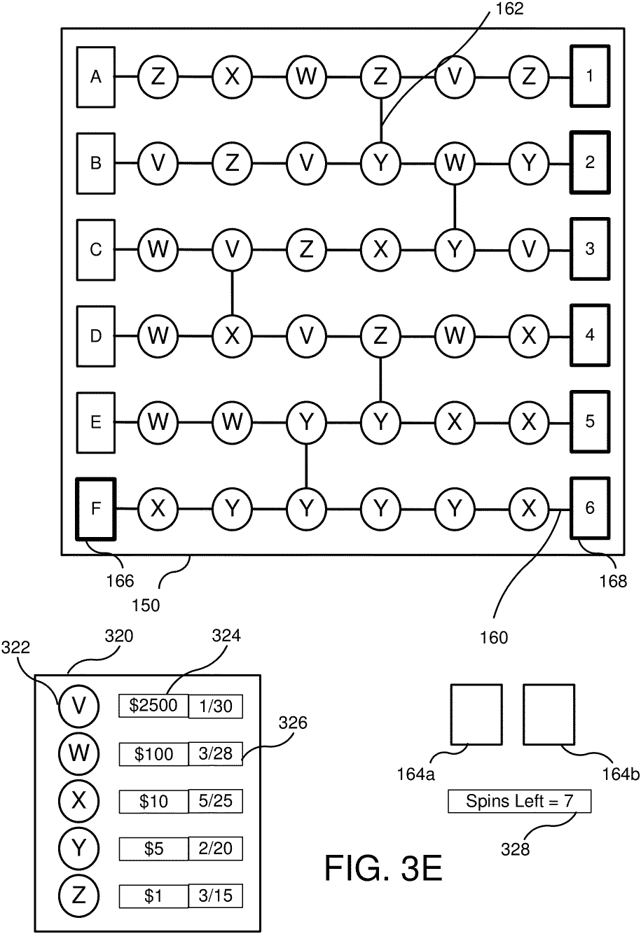

Reference is now made to FIGS. 3A-3E, which are schematic screen shots of a symbol game according to some embodiments herein. Referring to FIG. 3A, an empty cell grid 150 is displayed including the rows and the vertical connectors 162 in specific positions. A game symbol table 320 that may include game symbols 322, game symbol award values 324, and/or symbol collection progress data 326, among others. In some embodiments, starting and ending point selectors 164a, 164b and a spins remaining value 328 may be displayed.

Briefly referring to FIG. 3B, the game symbol table 320 is populated with the game symbols 322. Once the game symbols 322 are one the game symbol table 320, an input to determine a first round of game play by causing the starting and ending point selectors 164a, 164b to determine the starting and ending point values. For example, the starting and ending point values may be “F” and “2” for the first turn.

Brief reference is made to FIG. 3C, which illustrates that the path between the starting and ending points 166, 168 is highlighted.

Referring to FIG. 3D, the game symbols 322 that are along the highlighted path are collected and added to the symbol collection progress data 326. Referring to FIG. 3E, the remaining symbols drop down to fill the gaps left from the collected symbols and the empty cells are populated with new game symbols 322. The game may continue with another spin. Some embodiments provide that a player will win if they collect the requisite number of any of the play symbol types.

Although described in the context of symbols, embodiments herein may use different colors to distinguish the different cells from one another. Some embodiments provide that different colors may correspond to different values. In some embodiments, the combination of adjacent cells having the same symbol, value and/or color may be the basis for an award.

In some embodiments, each of the grid cells is populated with a die that may be rolled to determine which dice value is assigned to that grid cell. For example, each die may be a six-sided die and may be rolled to select one of six different values and/or symbols. A pair of spinners or other game initiation inputs may cause the starting and ending point selectors 164a, 164b to determine the starting and ending point values that determine the winning path. Any color and/or symbol clusters along the winning path may be awarded a prize in a single turn game. In the context of a multi-turn game, each symbol along the winning path may be added to a symbol score.

In some embodiments, the vertical connector 162 may move to different positions between turns. Some embodiments provide that once the vertical connectors 162 change positions, each of the die may be rolled again to determine which symbols are on the winning path. The symbols may be collected and the player may win by collecting the requisite number of symbols.

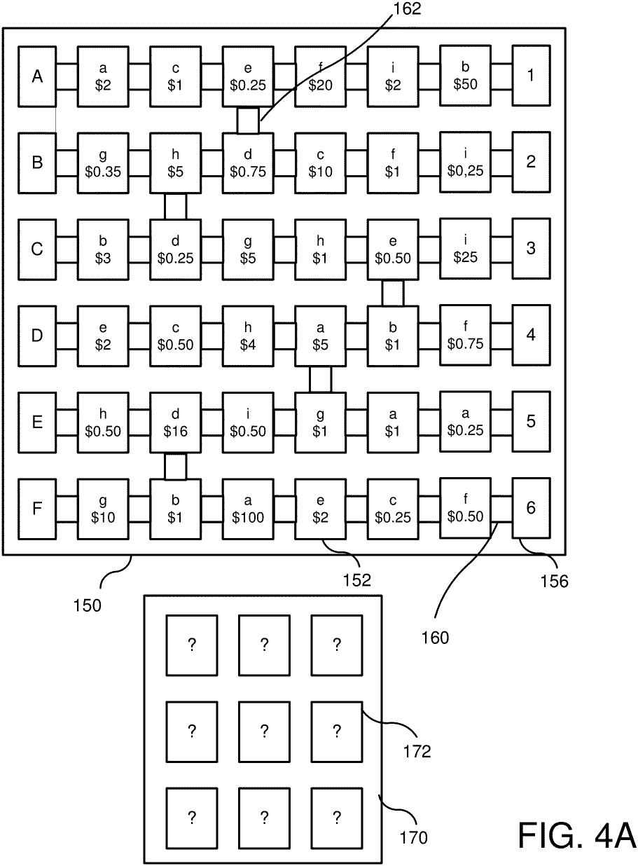

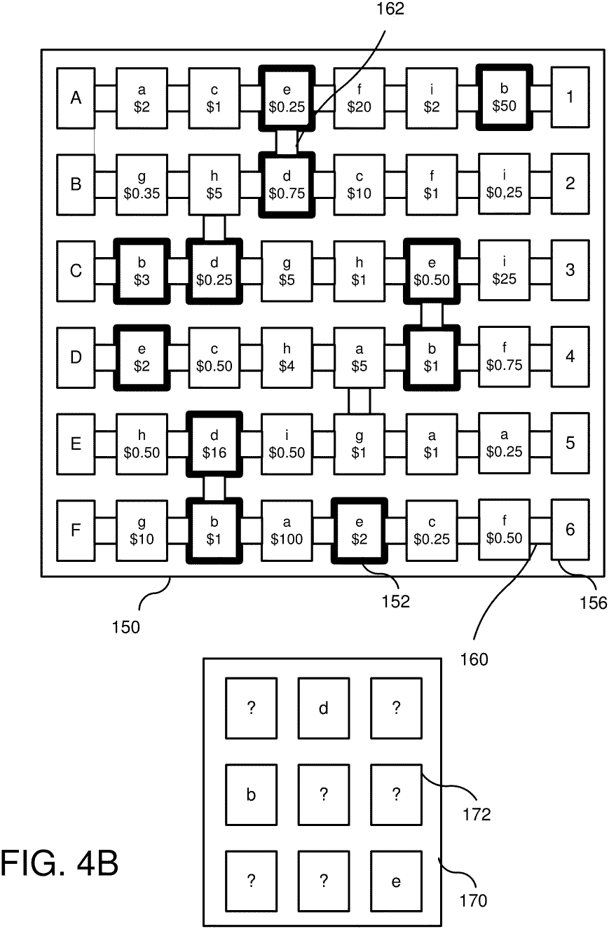

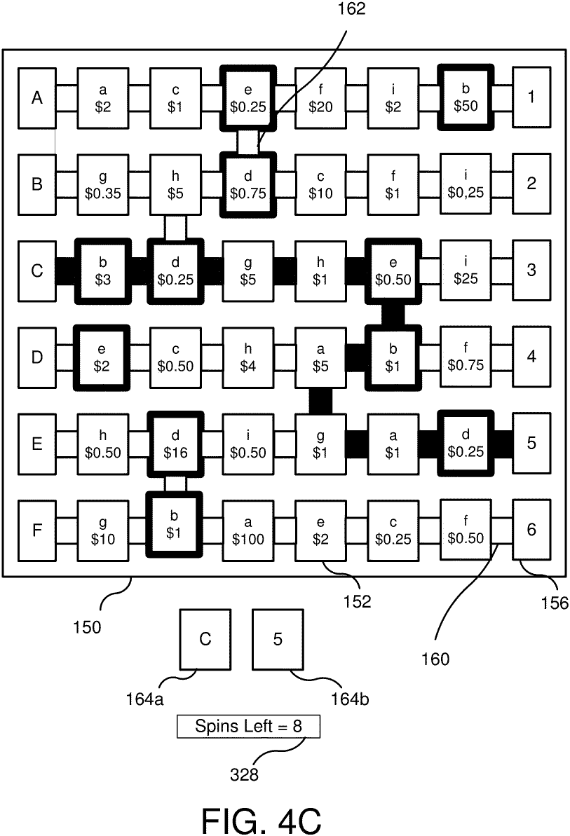

Reference is now made to FIGS. 4A-4C, which are schematic screen shots of a symbol game according to some embodiments herein. Referring to FIG. 4A, a cell grid 150 is displayed including the rows and the vertical connectors 162 in specific positions. In some embodiments, each of the grid cells 152 includes a symbol and a prize amount. A portion of the total available game symbols may be selected using a symbol selection interface 170. In some embodiments, the symbol selection interface may include a selection grid that includes the same number of selection cells 172 as the quantity of game symbols. For example, a symbol selection interface 170 may include 9 buttons that each correspond to a different one of the game symbols. Although illustrated as a selection grid, embodiments may include other interface types, such as, for example a spinner with a section corresponding to the quantity of game symbols. Once a selection is made, the section interface may be modified to only receive selections from previously unselected game symbols.

Referring to FIG. 4B, the player selects three of the selection cells 172 to reveal 3 three of the game symbols. The grid locations of the uncovered game symbols may be highlighted along with their corresponding prize amounts. In some embodiments, the unselected grid cells may be de-emphasized by graphically reducing and/or changing the appearance thereof.

Briefly referring to FIG. 4C, as provided above regarding FIG. 3A, spinners or other game initiation inputs may cause the starting and ending point selectors 164a, 164b to determine the starting and ending point values that determine the winning path. The prize path may be highlighted and the player may be awarded all of the highlighted prizes that are on the prize path.

Some embodiments provide multiple ticket games in which players may choose the different tickets having different quantities of rows of grid cells. For example, a player may choose to play 4 lines with 16 paths, 5 lines with 25 paths and/or 6 lines with 36 paths.

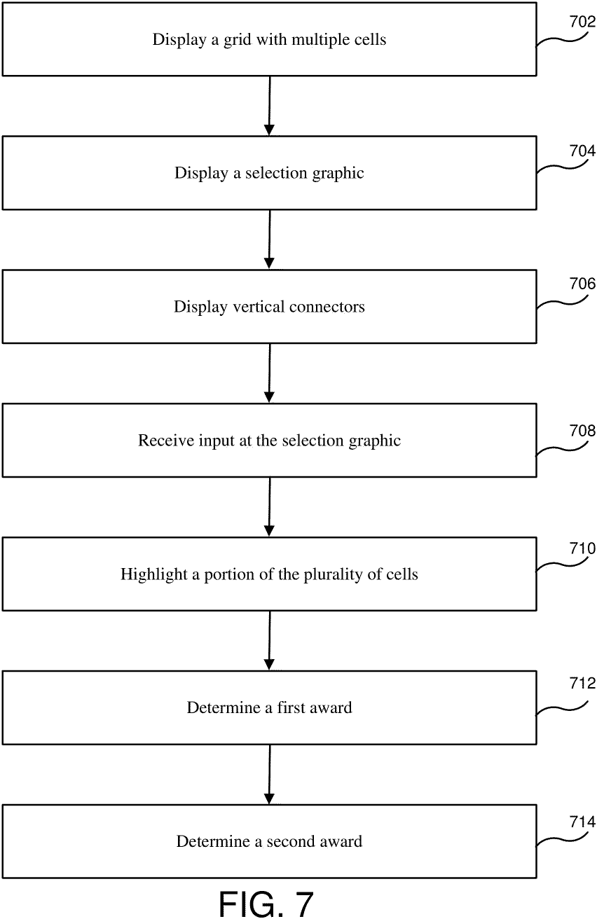

Reference is now made to FIG. 7, which is a flow chart of some embodiments of processes for operating a game providing instant win multiple path symbol matching according to some embodiments. Operations herein may be performed by an electronic gaming machine (EGM) that includes a processor circuit and a memory device that stores a multiple instructions that, when executed by the processor circuit, cause the processor circuit to perform such operations. Operations include, causing a display device to display (block 702) a grid including multiple cells that are arranged as rows of cells that each define a corresponding path between a first row identifier that corresponds to a beginning of the row and a second row identifier that corresponds to an end of the rows. Operations include causing the display device to display (block 704) a selection graphic that includes multiple mystery elements that each correspond to a different one of a plurality of symbol types that are configured to be displayed on the plurality of cells. The mystery cells may be removed to reveal the symbol types of the cells.

Operations include causing the display device to display (block 706) multiple vertical connectors that are arranged between adjacent ones of the rows of cells and may each be arranged between two adjacent ones of the rows. In some embodiments, the vertical connectors each comprise a merged cell that corresponds to a first cell in a given position on a first row and a second cell in the given position on a second row that is adjacent the first row. In some embodiments, the first cell includes a first symbol type and the second cell includes the first symbol type. Some embodiments provide that the first cell includes a first symbol type and the second cell includes a second type that is different from the first type.

Operations include receiving (block 708) an input at the selection graphic. The input may select a portion of the symbol types.

Operations include causing the display to highlight (block 710) a portion of the cells that include the portion of the symbol types. In response to determining that the portion of the cells that are highlighted include all of the cells in one of the rows, operations include determining (block 712) a first award that is identified based on the second row identifier of the corresponding row. In response to determining that the portion of the cells that are highlighted include highlighted ones of the cells that define a path that includes adjacent ones of a first portion of the cells on a first one of the rows, adjacent ones of a second portion of the cells one a second one of the rows, and one of the vertical connectors, operations include determining (block 714) a second award that is identified based on the second row identifier of the second one of the rows.

In some embodiments, the vertical connectors are arranged to be between a first cell in a given position on a first row and a second cell in the given position on a second row that is adjacent the first row.

Some embodiments provide that the display device is further caused to display the vertical connectors in random positions relative to cells in each of the rows of cells. In some embodiments, displaying the vertical connectors in random positions includes randomizing positions of the vertical connectors between rounds of the symbol match game. In some embodiments, displaying the vertical connectors includes displaying the vertical connectors in initial positions responsive to a start of the symbol match game and moving the vertical connectors in given directions before subsequently occurring rounds of the symbol match game.

In some embodiments, ones of the cells that define the path each include a cell value and the second award is further identified based on the cell value of each of the cells that define the path.

Some embodiments provide that the selection graphic includes a selection grid that includes the mystery elements, wherein responsive to one of the mystery elements being selected via the input, a selected symbol corresponding to one of the symbol types is displayed to replace the mystery element that was selected.

In some embodiments, the selection graphic includes a circular graphic that includes multiple wheel sections and that may be actuated via a spin input. In some embodiments, a stopping point of the circular graphic identifies a selected one of the wheel sections and the selected one of the wheel sections corresponds to one of the symbol types. In some embodiments, after the selected one of the wheel sections is determined, the circular graphic includes wheel sections that have not been selected.

Some embodiments provide that the display device is further caused to display a first row selector that is configured to receive an input that is used to identify the first row identifier that corresponds to a selected one of the rows that identifies a starting point for the path. In some embodiments, the display device is further caused to display a second row selector that is configured to receive an input that is used to identify the second row identifier that corresponds to a selected one of the rows that identifies either the first or second award. In some embodiments, the first row selector is depicted as a die and the second row selector is depicted as a second die. Some embodiments provide that a highlighted path of cells from the first row selector to the second row selector includes an award path, wherein the processor circuit is caused to determine the award to be based on values of all of the ones of the cells that are on the award path.

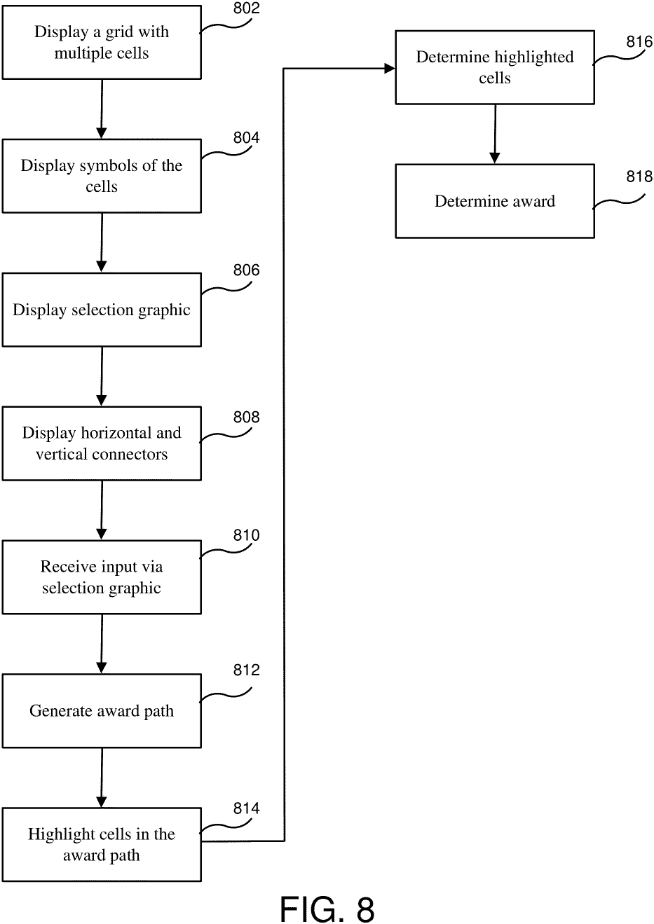

Reference is now made to FIG. 8, which is a flow chart of some embodiments of processes for operating a game providing instant win multiple path symbol matching according to some embodiments.

Operations include displaying (block 802), by a display device, a grid including multiple cells that are arranged as multiple rows of cells that correspond to paths between multiple beginning row identifiers and multiple ending row identifiers.

Operations include displaying (block 804), by the display device, multiple symbols on the cells. In some embodiments, the symbols include multiple symbol types that each include a portion of the symbols. Operations include displaying (block 806), by the display device, a selection graphic that includes a first spinner that is used to select one of the beginning row identifiers and a second spinner that is used to select one of the ending row identifiers.

Operations include displaying (block 808), by the display device, multiple horizontal connectors that are arranged between adjacent ones of the cells in each of the rows of cells and multiple vertical connectors that are arranged between adjacent ones of the rows of cells.

Operations include receiving (block 810), by the processor circuit and via the selection graphic, an input that selects one of the beginning row identifiers and one of the ending row identifiers.

Operations include generating (block 812) an award path between a selected one of the beginning row identifiers and a selected one of the ending row identifiers and that includes a first horizontal connector on a first row corresponding to the selected one of the beginning row identifiers, a second horizontal connector on a second row corresponding to the selected one of the ending row identifiers, and one of the vertical connectors.

Operations include highlighting (block 814) ones of the cells that are in the award path and determining that the cells that are highlighted include all of the cells in the award path. Operations include, responsive to determining the cells that are highlighted comprise all of the cells in the award path, determining (block 818) an award.

In some embodiments, the symbol types comprise different colors and the symbols comprise die having different colors.

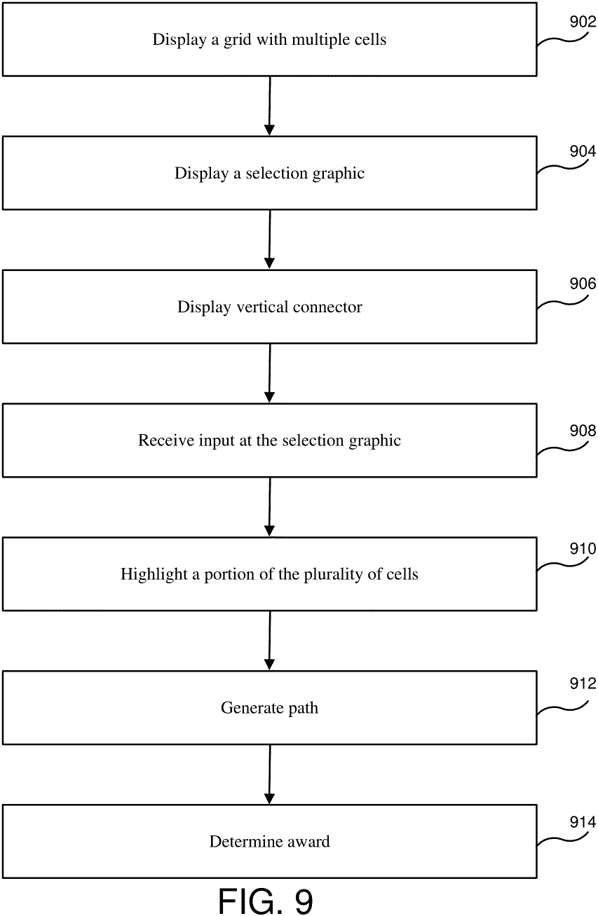

Reference is now made to FIG. 9, which is a flow chart of some embodiments of processes for operating an EGM providing instant win multiple path symbol matching according to some embodiments. Operations include displaying (block 902), using a display device, a grid including multiple cells and displaying (block 904), using the display device, a selection graphic that includes multiple mystery elements that each correspond to a different one of multiple symbol types that are configured to be displayed on the plurality of cells.

Operations include displaying (block 906), using the display device, a vertical connector that is arranged between two adjacent ones of the rows of cells and receiving (block 908), at the selection graphic, an input that selects a portion of the symbol types.

Operations include highlighting (block 910) a portion of the cells that include the portion of the symbol type and determining that the portion of the cells that are highlighted generate (block 912) a path from a first end of one of the adjacent rows of cells to a second end of another one of the adjacent one of rows of cells and that includes the vertical connector. Operations include determining (block 914) an award that is identified based on which symbols are on the plurality of cells that are in the award path.

### EGM Components

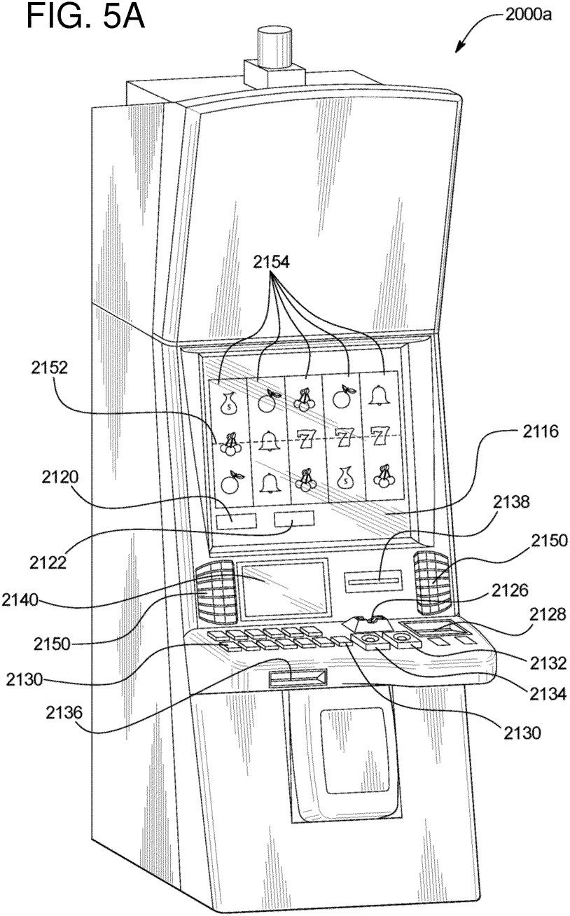

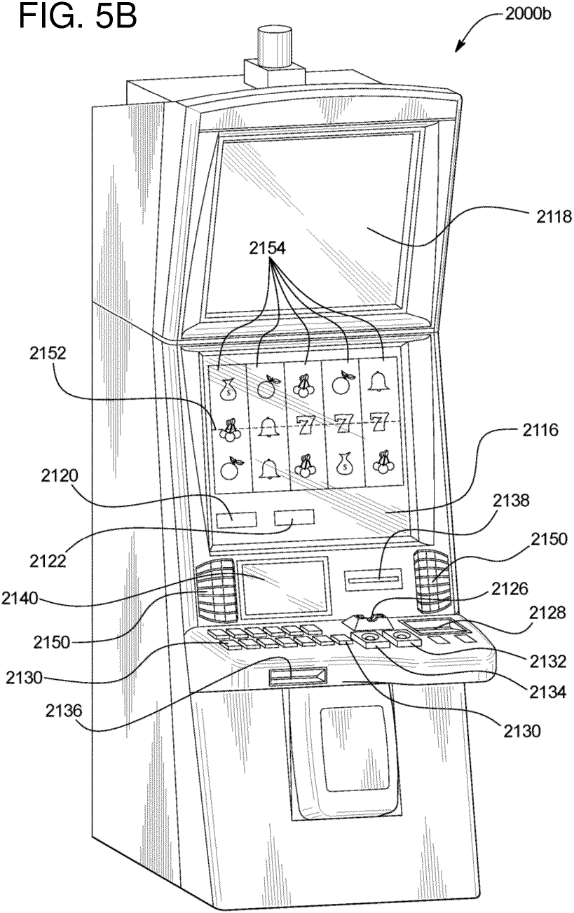

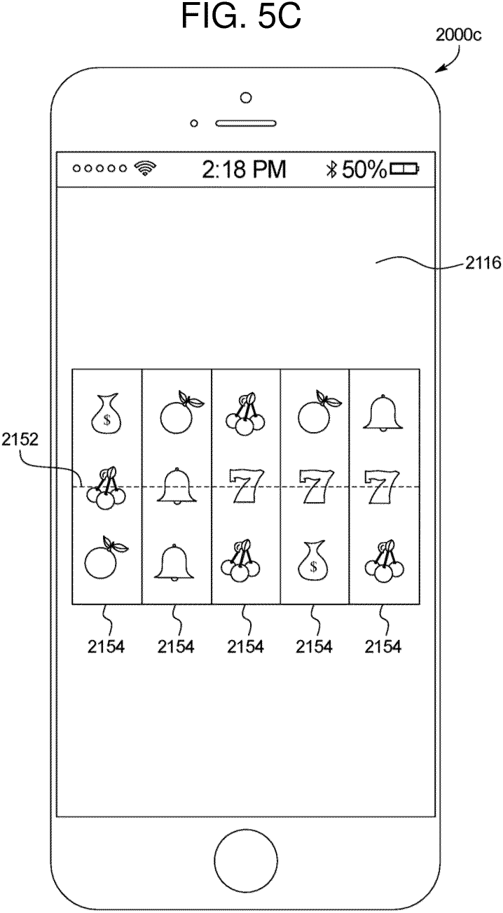

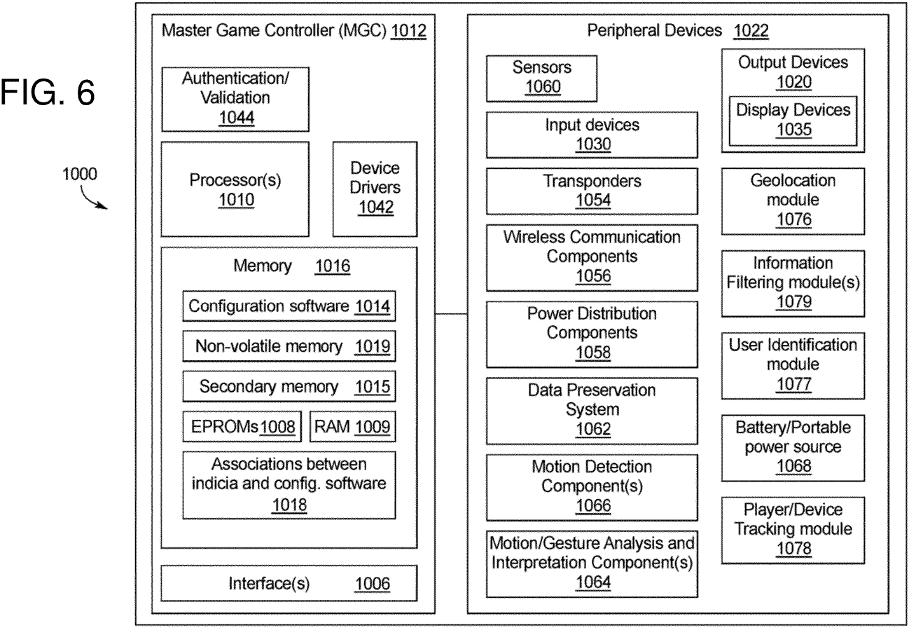

FIG. 6 is a block diagram of an example EGM 1000 and FIGS. 5A and 5B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 5C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM disclosed herein. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the player’s computer, partly on the player’s computer, as a stand-alone software package, partly on the player’s computer and partly on a remote computer or entirely on the remote computer or server. In the latter scenario, the remote computer may be connected to the player’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth.TM., near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, player input device components, information received from one or more player input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or noncontact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one player identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player’s player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 5A includes a central display device 2116, a player tracking display 2140, a credit display 2120, and a bet display 2122. The example EGM 2000b illustrated in FIG. 5B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player’s credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth.TM.); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more player input devices near the EGM. In one embodiment, a player input device docking region is provided, and includes a power distribution component that is configured to recharge a player input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., player input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player’s motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one player identification module 1077 is configured to determine the identity of the current player or current owner of the EGM. For example, in one embodiment, the current player is required to perform a login process at the EGM in order to access one or more features. Alternatively, the EGM is configured to automatically determine the identity of the current player based on one or more external signals, such as an RFID tag or badge worn by the current player and that provides a wireless signal to the EGM that is used to determine the identity of the current player. In at least one embodiment, various security features are incorporated into the EGM to prevent unauthorized players from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all gaming systems, and these example EGMs may not include one or more elements that are included in other gaming systems. For example, certain EGMs include a coin acceptor while others do not.

### Operation of Primary or Base Games And/or Secondary or Bonus Games

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database configured to store player profiles, (b) a player tracking module configured to track players (as described below), and (c) a credit system configured to provide automated transactions.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGM 2000b shown in FIG. 5B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments, entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player’s gaming activity. In one such embodiment, the player tracking system does so through the use of player tracking cards. In this embodiment, a player is issued a player identification card that has an encoded player identification number that uniquely identifies the player. When the player’s playing tracking card is inserted into a card reader of the gaming system to begin a gaming session, the card reader reads the player identification number off the player tracking card to identify the player. The gaming system timely tracks any suitable information or data relating to the identified player’s gaming session. The gaming system also timely tracks when the player tracking card is removed to conclude play for that gaming session. In another embodiment, rather than requiring insertion of a player tracking card into the card reader, the gaming system utilizes one or more portable devices, such as a mobile phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player’s account number, the player’s card number, the player’s first name, the player’s surname, the player’s preferred name, the player’s player tracking ranking, any promotion status associated with the player’s player tracking card, the player’s address, the player’s birthday, the player’s anniversary, the player’s recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

### Web-Based Gaming

In various embodiments, the gaming system includes one or more servers configured to communicate with a personal gaming device--such as a smartphone, a tablet computer, a desktop computer, or a laptop computer--to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player’s unique player name and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player’s account balance. In other embodiments, the one or more servers enable the player to make a payment using the player’s credit card, debit card, or other suitable device to add money to the player’s account balance. In other embodiments, the one or more servers enable the player to add money to the player’s account balance via a peer-to-peer type application, such as PayPal or Venmo. The one or more servers also enable the player to cash out the player’s account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player’s account balance can cover the desired wager (i.e., includes a monetary balance at least equal to the desired wager).

If the payment server determines that the player’s account balance cannot cover the desired wager, the payment server notifies the game server, which then instructs the personal gaming device to display a suitable notification to the player that the player’s account balance is too low to place the desired wager. If the payment server determines that the player’s account balance can cover the desired wager, the payment server deducts the desired wager from the account balance and notifies the game server. The game server then determines an outcome and any associated award for the play of the game. The game server notifies the payment server of any nonzero award, and the payment server increases the player’s account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the gaming system includes an EGM configured to communicate with a personal gaming device--such as a smartphone, a tablet computer, a desktop computer, or a laptop computer--to enable tethered mobile game play using the personal gaming device. Generally, in these embodiments, the EGM establishes communication with the personal gaming device and enables the player to play games on the EGM remotely via the personal gaming device. In certain embodiments, the gaming system includes a geo-fence system that enables tethered game play within a particular geographic area but not outside of that geographic area.

### Social Network Integration

In certain embodiments, the gaming system is configured to communicate with a social network server that hosts or partially hosts a social networking website via a data network (such as the Internet) to integrate a player’s gaming experience with the player’s social networking account. This enables the gaming system to send certain information to the social network server that the social network server can use to create content (such as text, an image, and/or a video) and post it to the player’s wall, newsfeed, or similar area of the social networking website accessible by the player’s connections (and in certain cases the public) such that the player’s connections can view that information. This also enables the gaming system to receive certain information from the social network server, such as the player’s likes or dislikes or the player’s list of connections. In certain embodiments, the gaming system enables the player to link the player’s player account to the player’s social networking account(s). This enables the gaming system to, once it identifies the player and initiates a gaming session (such as via the player logging in to a website (or an application) on the player’s personal gaming device or via the player inserting the player’s player tracking card into an EGM), link that gaming session to the player’s social networking account(s). In other embodiments, the gaming system enables the player to link the player’s social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the gaming system sends information about the award to the social network server to enable the server to create associated content (such as a screenshot of the outcome and associated award) and to post that content to the player’s wall (or other suitable area) of the social networking website for the player’s connections to see (and to entice them to play). In another embodiment, if a player joins a multiplayer game and there is another seat available, the gaming system sends that information to the social network sever to enable the server to create associated content (such as text indicating a vacancy for that particular game) and to post that content to the player’s wall (or other suitable area) of the social networking website for the player’s connections to see (and to entice them to fill the vacancy). In another embodiment, if the player consents, the gaming system sends advertisement information or offer information to the social network server to enable the social network server to create associated content (such as text or an image reflecting an advertisement and/or an offer) and to post that content to the player’s wall (or other suitable area) of the social networking website for the player’s connections to see. In another embodiment, the gaming system enables the player to recommend a game to the player’s connections by posting a recommendation to the player’s wall (or other suitable area) of the social networking website.

### Differentiating Certain Gaming Systems from General Purpose Computing Devices

Certain of the gaming systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM’s hardware and software in a manner that gives him an unfair, and in some cases illegal, advantage.

A third difference between EGMs and general purpose computing devices is authentication--EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player’s wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player’s assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT’s Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other’s identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. An electronic gaming machine (EGM) comprising:
a processor circuit; and
a memory device that stores a plurality of instructions that, when executed by the processor circuit, cause the processor circuit to:
cause a display device to display a grid comprising a plurality of cells that are arranged as a plurality of rows of cells that each define a corresponding path between a first row identifier that corresponds to a beginning of the row and a second row identifier that corresponds to an end of the plurality of rows;
cause the display device to display a selection graphic that comprises a plurality of mystery elements that each correspond to a different one of a plurality of symbol types that are configured to be displayed on the plurality of cells;
cause the display device to display a plurality of vertical connectors that are arranged between adjacent ones of the plurality of rows of cells, one of the plurality of vertical connectors being arranged between two adjacent ones of the plurality of rows;
receive at the selection graphic, an input that selects a portion of the plurality of symbol types;
cause the display to highlight a portion of the plurality of cells that include the portion of the plurality of symbol types;
responsive to determining that the portion of the plurality of cells that are highlighted include all of the cells in one of the plurality of rows, determine a first award that is identified based on the second row identifier of the corresponding row; and
responsive to determining that the portion of the plurality of cells that are highlighted include highlighted ones of the cells that define a path that includes adjacent ones of a first portion of the plurality of cells on a first one of the plurality of rows, adjacent ones of a second portion of the plurality of cells one a second one of the plurality of rows, and one of the vertical connectors, determine a second award that is identified based on the second row identifier of the second one of the plurality of rows,
wherein the plurality of vertical connectors each comprise a merged cell that corresponds to a first cell in a given position on a first row and a second cell in the given position on a second row that is adjacent the first row.

2. (canceled)

3. The EGM of claim 2, wherein the first cell comprises a first symbol type and the second cell comprises the first symbol type.

4. The EGM of claim 2, wherein the first cell comprises a first symbol type and the second cell comprises a second type that is different from the first type.

5. The EGM of claim 1, wherein the plurality of vertical connectors are arranged to be between a first cell in a given position on a first row and a second cell in the given position on a second row that is adjacent the first row.

6. The EGM of claim 1, wherein the display device is further caused to display the plurality of vertical connectors in random positions relative to cells in each of the plurality of the rows of cells.

7. The EGM of claim 6, wherein displaying the plurality of vertical connectors in random positions comprises randomizing positions of the plurality of vertical connectors between rounds of the symbol match game.

8. The EGM of claim 1, wherein displaying the plurality of vertical connectors comprises displaying the plurality of vertical connectors in initial positions responsive to a start of the symbol match game and moving the plurality of vertical connectors in given directions before subsequently occurring rounds of the symbol match game.

9. The EGM of claim 1,
wherein ones of the cells that define the path each comprise a cell value, and
wherein the second award is further identified based on the cell value of each of the cells that define the path.

10. The EGM of claim 1, wherein the selection graphic comprises a selection grid that comprises the plurality of mystery elements, wherein responsive to one of the mystery elements being selected via the input, a selected symbol corresponding to one of the plurality of symbol types is displayed to replace the mystery element that was selected.

11. The EGM of claim 1, wherein the selection graphic comprises a circular graphic that comprises a plurality of wheel sections and that may be actuated via a spin input, wherein a stopping point of the circular graphic identifies a selected one of the plurality of wheel sections, and wherein the selected one of the plurality of wheel sections corresponds to one of the plurality of symbol types.

12. The EGM of claim 12, wherein after the selected one of the wheel sections is determined, the circular graphic comprises wheel sections that have not been selected.

13. The EGM of claim 1, wherein the display device is further caused to display a first row selector that is configured to receive an input that is used to identify the first row identifier that corresponds to a selected one of the plurality of rows that identifies a starting point for the path.

14. The EGM of claim 13, wherein the display device is further caused to display a second row selector that is configured to receive an input that is used to identify the second row identifier that corresponds to a selected one of the plurality of rows that identifies either the first or second award.

15. The EGM of claim 14, wherein the first row selector is depicted as a die and the second row selector is depicted as a second die.

16. The EGM of claim 14, wherein a highlighted path of cells from the first row selector to the second row selector comprises an award path, wherein the processor circuit is caused to determine the award to be based on values of all of the ones of the plurality of cells that are on the award path.

17. A computer implemented method comprising:
displaying, by a display device, a grid comprising a plurality of cells that are arranged as a plurality of rows of cells that correspond to paths between a plurality of beginning row identifiers and a plurality of ending row identifiers;
displaying, by the display device, a plurality of symbols on the plurality of cells, the plurality of symbols comprising a plurality of symbol types that each comprise a portion of the plurality of symbols;
displaying, by the display device, a selection graphic that comprises a first spinner that is used to select one of the plurality of beginning row identifiers and a second spinner that is used to select one of the plurality of ending row identifiers;
displaying, by the display device, a plurality of horizontal connectors that are arranged between adjacent ones of the plurality of cells in each of the plurality of rows of cells and a plurality of vertical connectors that are arranged between adjacent ones of the plurality of rows of cells;
receiving, by the processor circuit and via the selection graphic, an input that selects one of the plurality of beginning row identifiers and one of the plurality of ending row identifiers;
generating an award path between a selected one of the plurality of beginning row identifiers and a selected one of the plurality of ending row identifiers and that comprises a first horizontal connector on a first row corresponding to the selected one of the beginning row identifiers, a second horizontal connector on a second row corresponding to the selected one of the ending row identifiers, and one of the plurality of vertical connectors;
highlighting ones of the plurality of cells that are in the award path;
determining the plurality of cells that are highlighted comprise all of the cells in the award path; and
responsive to determining the plurality of cells that are highlighted comprise all of the cells in the award path, determining an award,
wherein the plurality of vertical connectors each comprise a merged cell that corresponds to a first cell in a given position on a first row and a second cell in the given position on a second row that is adjacent the first row.

18. The method of claim 17, wherein the plurality of symbol types comprise different colors, and wherein the plurality of symbols comprise die having the different colors.

19. The method of claim 18, wherein between rounds receiving the input that selects one of the plurality of beginning row identifiers and one of the plurality of ending row identifiers is performed a plurality of times during a game, and
wherein the displaying the plurality of symbols on the plurality of cells comprises replacing cells that comprise previously selected ones of the plurality of symbols with updated symbols.

20. A method of operating an electronic gaming machine (EGM) comprising:
displaying, using a display device, a grid comprising a plurality of cells;
displaying, using the display device, a selection graphic that comprises a plurality of mystery elements that each correspond to a different one of a plurality of symbol types that are configured to be displayed on the plurality of cells;
displaying, using the display device, a vertical connector that is arranged between two adjacent ones of the plurality of rows of cells;
receiving, at the selection graphic, an input that selects a portion of the plurality of symbol types;
highlighting a portion of the plurality of cells that include the portion of the plurality of symbol types;
determining that the portion of the plurality of cells that are highlighted generate a path from a first end of one of the adjacent plurality of rows of cells to a second end of another one of the adjacent plurality of one of rows of cells and that includes the vertical connector; and
determining an award that is identified based on which symbols are on the plurality of cells that are in the award path,
wherein the vertical connector is arranged to be between a first cell in a given position on a first row and a second cell in a position on a second row that is adjacent the first row.
